(19) United States
(12) Patent Application Publication
(10) Pub. No.: US 2025/0261819 A1
(43) Pub. Date: Aug. 21, 2025

(54) Trailer Dustpan

(71) Applicant: Romell Terrell Cotton, Anderson, IN (US)

(72) Inventor: Romell Terrell Cotton, Anderson, IN (US)

(21) Appl. No.: 19/022,877

(22) Filed: Jan. 15, 2025

Related U.S. Application Data
(60) Provisional application No. 63/554,757, filed on Feb. 16, 2024.

(51) Int. Cl. A47L 13/52; B60S 3/00

(52) U.S. Cl. CPC A47L 13/52; B60S 3/008

(57) ABSTRACT

A trailer dustpan includes a first lateral wall having a first end and a second end, a second lateral wall having a first end and a second end, and an end plate. The first lateral wall and the second lateral wall are joined at an angle to form a V-shaped channel, and the end plate is attached between the first end of the first lateral wall and the first end of the second lateral wall.

### FIELD OF THE INVENTION

The present invention relates generally to cleaning and maintenance tools. More specifically, the present invention is a trailer dustpan that collects sweepings from the inside of a semi-trailer for proper disposal. The present invention is specifically designed for semi-trailers. However, the present invention is not limited to this option, and it may further be adapted for different purposes.

### BACKGROUND OF THE INVENTION

Cleaning inside a semi-trailer is a critical aspect of maintaining hygiene, safety, and compliance with regulatory standards in the transportation industry. Semi-trailers, which are integral components of freight transportation, carry a wide variety of goods across long distances, often traversing different climates and environments. The interior of these trailers can accumulate dirt, debris, spills, and residue from transported goods, posing sanitation concerns and potential hazards if left unattended.

Cleaning the inside of a semi-trailer involves several steps and considerations. Firstly, it requires the removal of any remaining cargo or items, ensuring that the interior space is clear and accessible for cleaning procedures. Next, surfaces such as walls, floors, ceilings, and cargo securing mechanisms need to be thoroughly cleaned and sanitized to eliminate any contaminants or odors.

Depending on the type of cargo transported, specialized cleaning agents and equipment may be necessary to address specific stains, residues, or spills effectively. For example, trailers that carry food products require stringent cleaning protocols to prevent cross-contamination and maintain compliance with food safety regulations.

It is not uncommon to find drivers cleaning the inside of their trailers with normal cleaning supplies such as brooms, but this creates a problem as where they clean and where they dispose of the debris can be difficult to do and can carry fines or be potentially damaging to the driver's reputation if done improperly. For instance, if drivers sweep the debris from the inside of their trailer onto the floor this can result in various penalties and consequences, particularly in industries where adherence to cleanliness, safety, and environmental regulations is paramount. Such actions may lead to fines imposed by regulatory bodies like the Department of Transportation (DOT) or environmental agencies, with penalties varying based on the severity of the violation and applicable regulations. Moreover, this practice could constitute a violation of transportation regulations and environmental laws, inviting citations or penalties from regulatory authorities and potentially tarnishing the compliance record of the responsible entity. Environmental damage is also a concern, as debris left on the floor might contain substances harmful to the environment, potentially triggering further penalties for contamination or ecological harm. Additionally, there are safety risks associated with leaving debris on the floor, including slips, trips, and falls that could result in injuries and liability issues. Such negligence may also cause damage to equipment used for loading and unloading cargo, incurring repair costs and operational disruptions. Beyond immediate repercussions, there's a risk of damaging the company's reputation, affecting relationships with customers, partners, and stakeholders due to negative publicity stemming from regulatory violations.

Therefore, it is an objective of the present invention to provide a debris disposal solution for drivers who clean the inside of their semi-trailers.

### SUMMARY OF THE INVENTION

The present invention discloses a trailer dustpan. It comprises a first lateral wall having a first end and a second end, a second lateral wall having a first end and a second end, and an end plate. The first lateral wall and the second lateral wall are joined at an angle to form a V-shaped channel, and the end plate is attached between the first end of the first lateral wall and the first end of the second lateral wall.

In one embodiment, the first lateral wall and the second lateral wall are joined at a right angle.

In one embodiment, the first lateral wall comprises a first section and a second section along a length of the first lateral wall, while the second lateral wall comprises a first section and a second section along a length of the second lateral wall.

In one embodiment, the first section of the first lateral wall has a same length as the first section of the second lateral wall, while the second section of the first lateral wall has a same length as the second section of the second lateral wall.

In one embodiment, the first section and second section of the first lateral wall are joined together via a first pivot mechanism, and the first section and second section of the second lateral wall are joined together via a second pivot mechanism.

In one embodiment, the second section of the first lateral wall is joined onto the second section of the second lateral wall via a third pivot mechanism.

In one embodiment, the end plate is attached to the first end of the first lateral wall via a fourth pivot mechanism.

In one embodiment, the end plate further comprises a latch, and the second lateral wall further comprises a catch.

In one embodiment, the first lateral wall further comprises a plurality of gusset plates.

In one embodiment, each of the plurality of gusset plates is attached to the first lateral wall via a fifth pivot mechanism.

In one embodiment, at least one of the first pivot mechanism, the second pivot mechanism, the third pivot mechanism, the fourth pivot mechanism, and the fifth pivot mechanism is hinges.

In one embodiment, the hinges are spring-loaded.

In one embodiment, the present invention further comprises a bracket having a first end and a second end. Each of the first end and the second end of the bracket comprises a claw and a positioning nub. The first lateral wall and the second lateral wall each comprises, adjacent to their respective second end, a positioning hole to receive the positioning nub and a cutout portion to receive the claw.

In one embodiment, the present invention further comprises at least one strap. The second lateral wall further comprises at least one strap hole. One end of the at least one strap is attached to the at least one strap hole, with another end attached to a rear end of a semi-trailer.

In one embodiment, the present invention further comprises a plurality of L-shaped mounting arms. The first lateral wall further comprises a plurality of mounting holes. The plurality of mounting arms is attached to the first lateral wall via the plurality of mounting holes.

### BRIEF DESCRIPTION OF THE DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the present invention. That is, the dimensions of the components of the present invention, independently and in relation to each other can be different. It should be noted that the drawings are schematic and not necessarily drawn to scale. Some drawings are enlarged or reduced to improve drawing legibility.

FIG. 1 depicts a perspective view of the present invention.

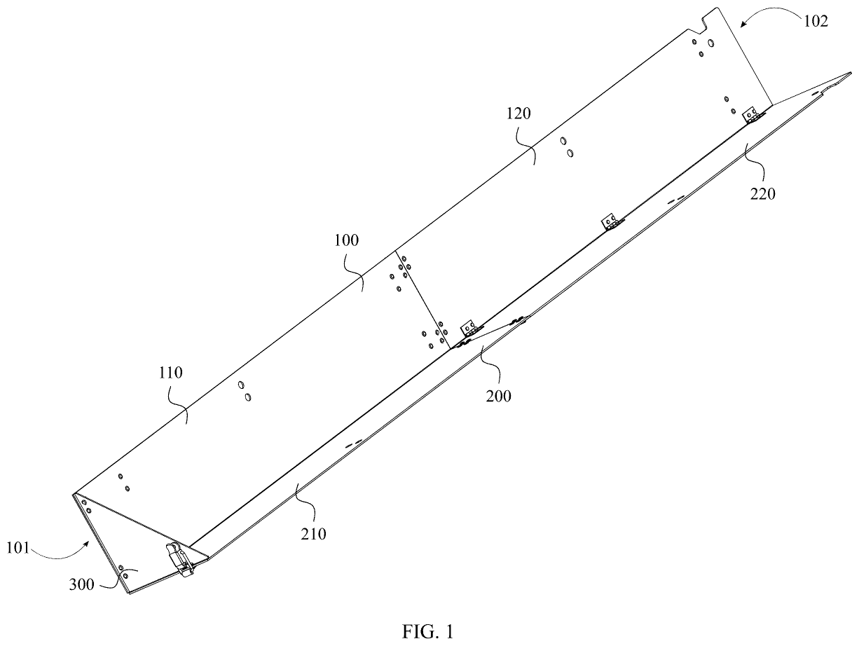

FIG. 2 depicts another perspective view of the present invention.

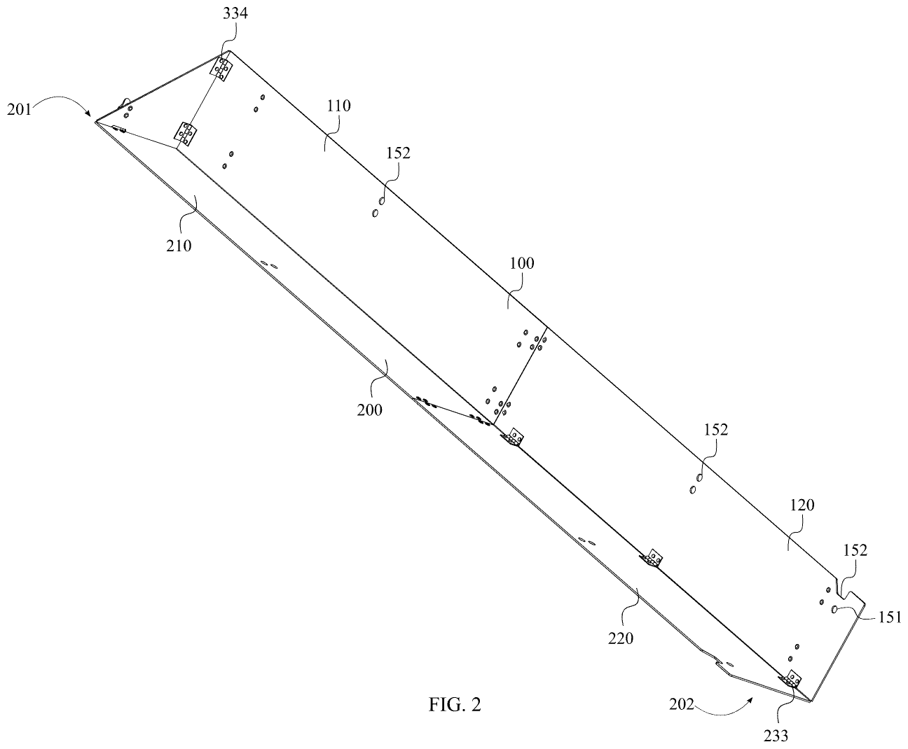

FIG. 3 depicts yet another perspective view of the present invention.

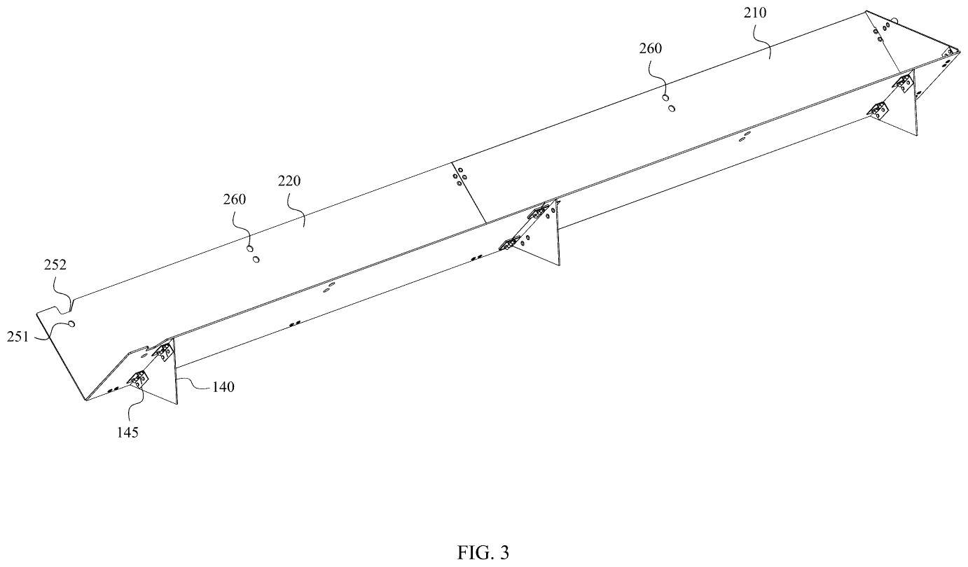

FIG. 4 depicts a front view of the present invention.

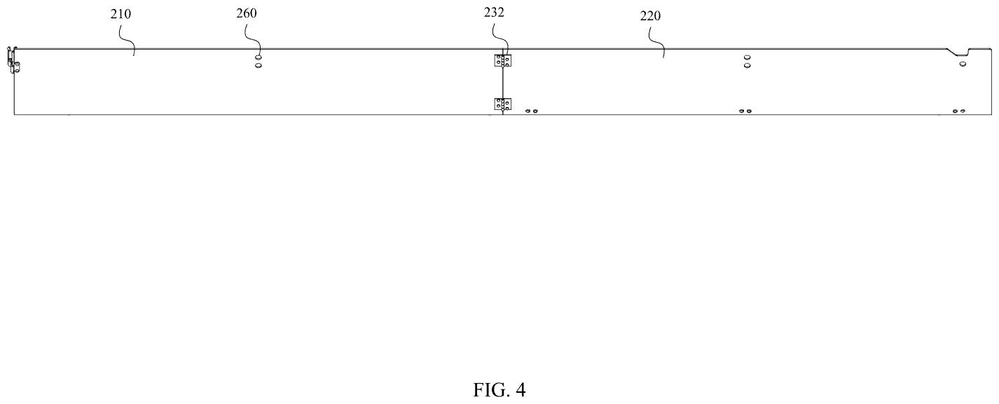

FIG. 5 depicts a back view of the present invention.

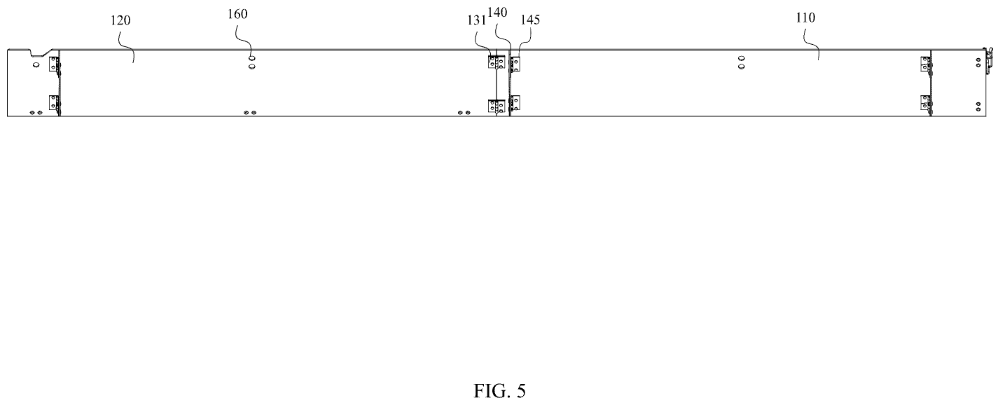

FIG. 6 depicts a top view of the present invention.

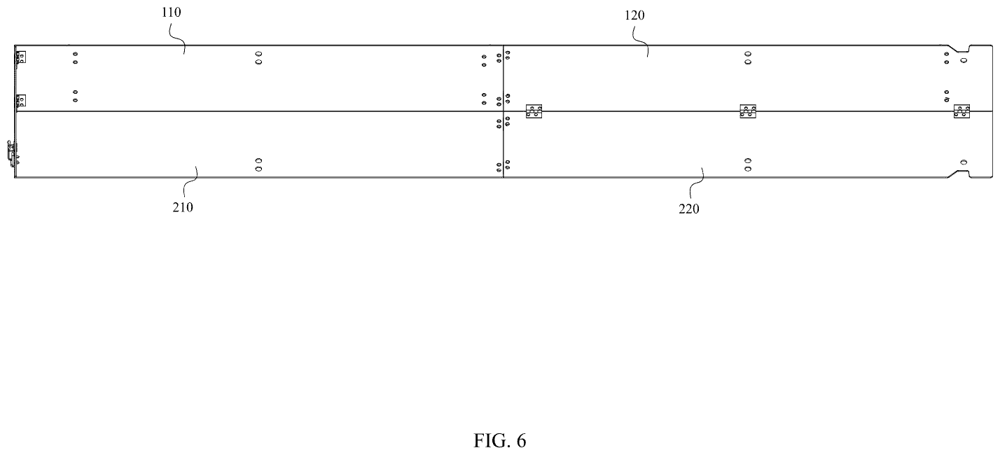

FIG. 7 depicts a bottom view of the present invention.

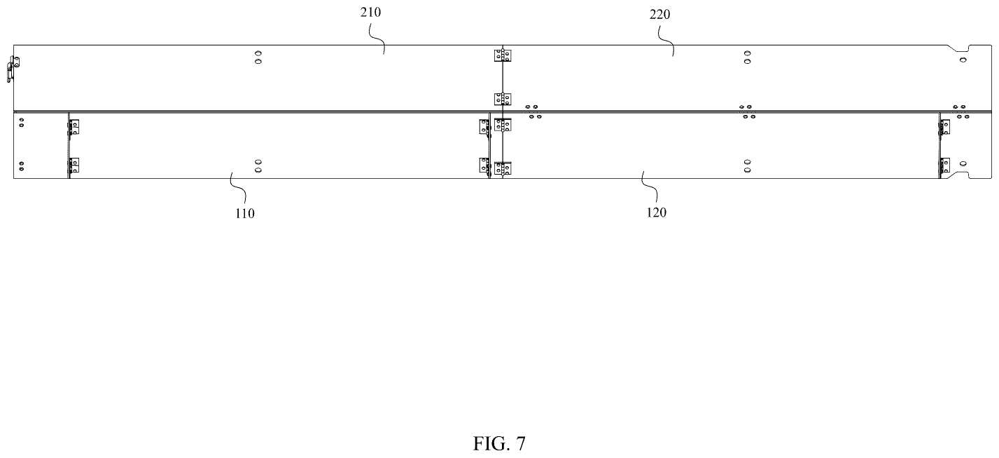

FIG. 8 depicts a left-side view of the present invention.

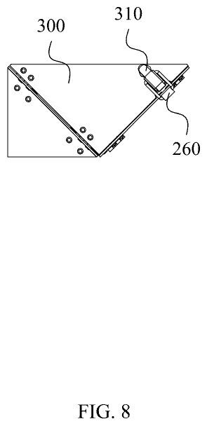

FIG. 9 depicts a right-side view of the present invention.

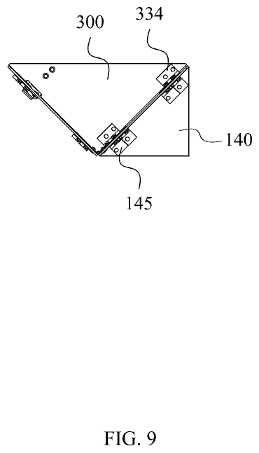

FIG. 10 depicts a perspective view of the present invention attached to the rear end of a semi-trailer.

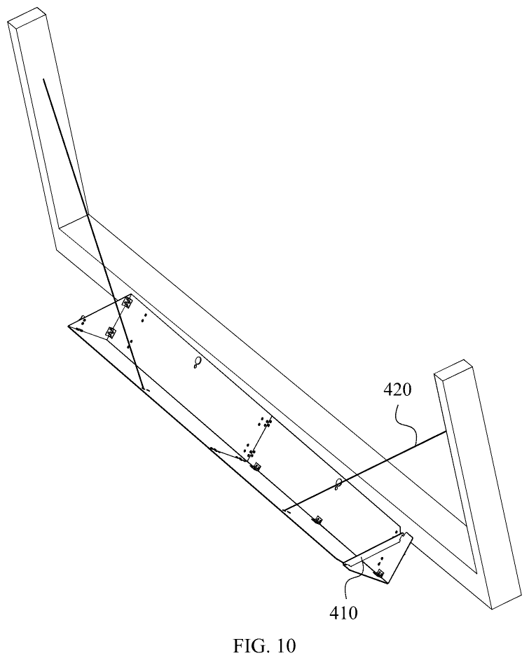

FIG. 11 depicts another perspective view of the present invention attached to the rear end of a semi-trailer.

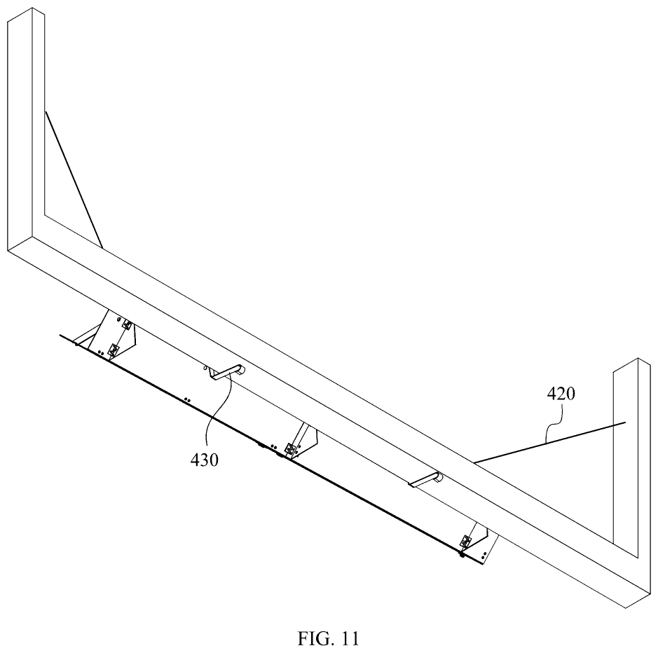

FIG. 12 depicts a front view of the present invention attached to the rear end of a semi-trailer.

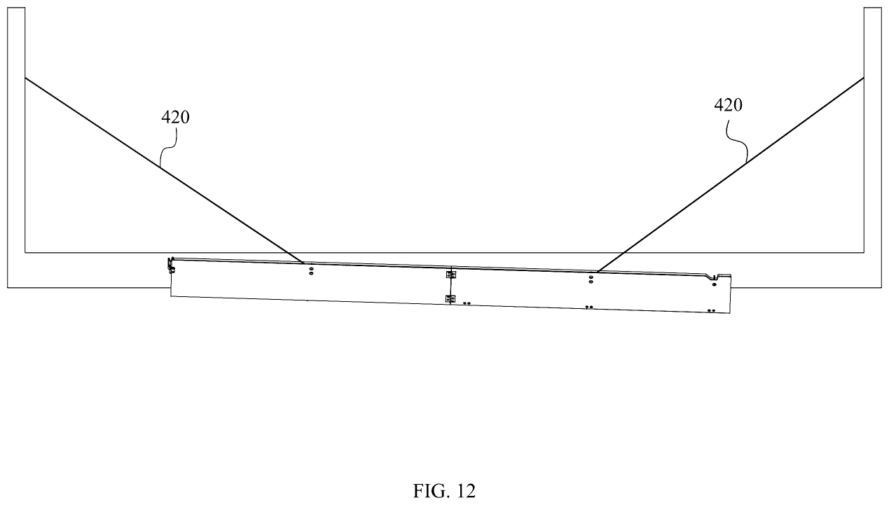

FIG. 13 depicts a perspective view of another embodiment of the present invention.

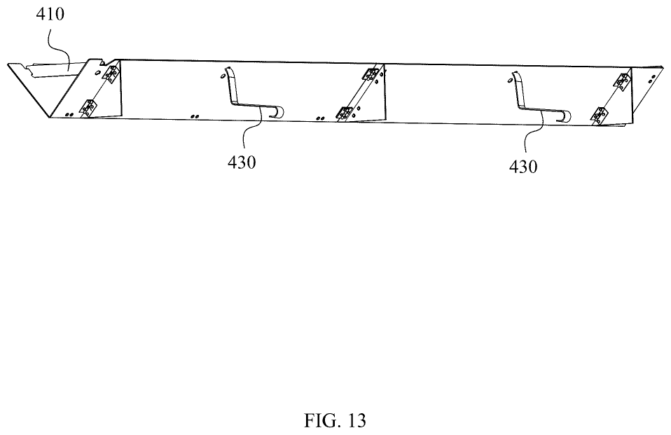

FIG. 14 depicts a perspective view of the bracket of the present invention.

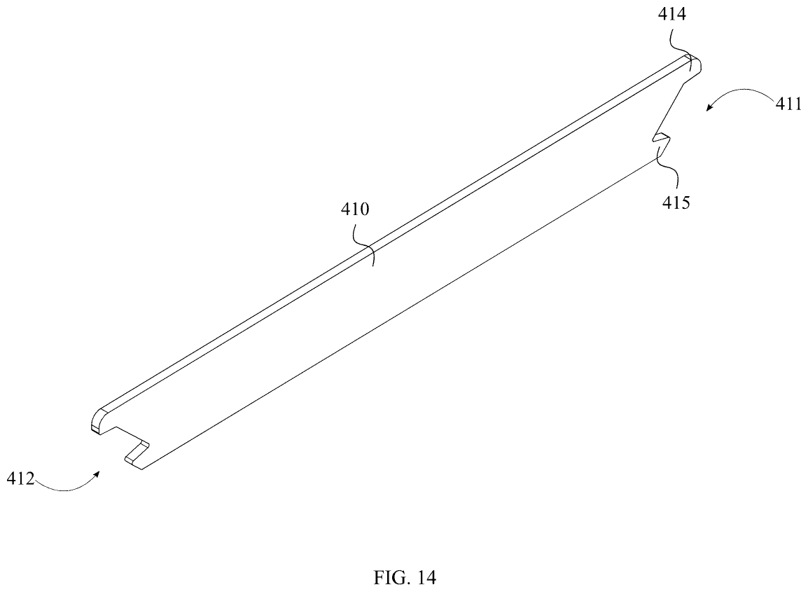

FIG. 15 depicts a perspective view of the arm of the present invention.

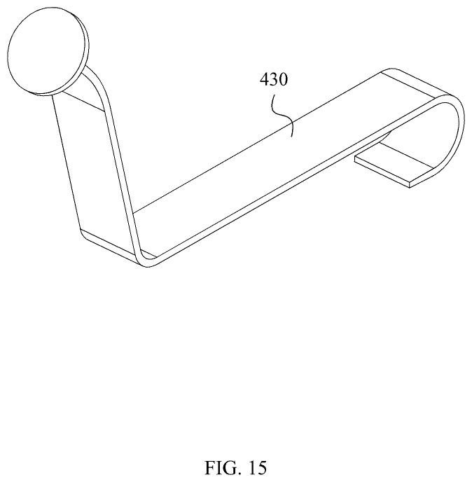

FIG. 16 depicts another perspective view of the arm of the present invention.

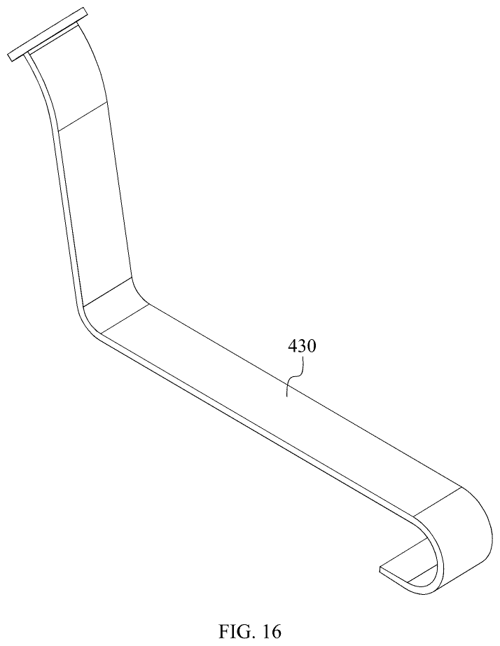

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. When not explicitly defined herein, to the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Other technical advantages may become readily apparent to one of ordinary skill in the art after review of the following figures and description. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise indicated, the drawings are intended to be read together with the specification and are to be considered a portion of the entire written description of this invention. As used in the following description, the terms “horizontal”, “vertical”, “left”, “right”, “up”, “down” and the like, as well as adjectival and adverbial derivatives thereof (e.g., “horizontally”, “rightwardly”, “upwardly”, “radially”, etc.), simply refer to the orientation of the illustrated structure as the particular drawing figure faces the reader. Similarly, the terms “inwardly,” “outwardly” and “radially” generally refer to the orientation of a surface relative to its axis of elongation, or axis of rotation, as appropriate. As used herein, the term “proximate” refers to positions that are situated close/near in relationship to a structure. As used in the following description, the term “distal” refers to positions that are situated away from positions.

The present disclosure includes many aspects and features. Moreover, while many aspects and features relate to, and are described in the context of trailer dustpans, embodiments of the present disclosure are not limited to use only in this context.

The present invention is a trailer dustpan that is specifically designed for semi-trailers. It is an aim of the present invention to provide a debris capture apparatus that allows a user to collect sweepings from the inside of a semi-trailer for proper disposal. It is another aim of the present invention to provide a trailer dustpan that is simple in structure, inexpensive to manufacture, and easy to use.

Referring now to the figures of the present disclosure. The trailer dustpan of the present invention comprises a first lateral wall 100, a second lateral wall 200, and an end plate 300.

The first lateral wall 100 has a first end 101 and a second end 102, while the second lateral wall 200 has a first end 201 and a second end 202. The first lateral wall 100 and the second lateral wall 200 are joined at an angle to form a V-shaped channel. In a preferred embodiment, the first lateral wall and the second lateral wall are joined at a right angle. The end plate is attached between the first end 101 of the first lateral wall 100 and the first end 201 of the second lateral wall 200. In this way, the V-shaped channel has a bounded end and an open end. When the trailer dustpan is installed on the rear end of a semi-trailer's open cargo area, the open end may be positioned opposite to the cleared area from where the user is able to climb in and out of the semi-trailer's compartment. In one embodiment, the trailer dustpan may include attachments on the open end that allow for the placement of an open trash bag to capture debris and refuse that is collected in the V-shaped channel. The open end may utilize clips and/or other types of fasteners to hold the trash bag open and in place and to prevent tearing of the bag when filled or removed.

In a preferred embodiment, the first lateral wall 100 comprises a first section 110 and a second section 120 along a length of the first lateral wall 100, while the second lateral wall 200 comprises a first section 210 and a second section 220 along a length of the second lateral wall 200. This configuration allows for a compact form when the present invention is not in use. In one embodiment, The first section 110 of the first lateral wall 100 has a same length as the first section 210 of the second lateral wall 200, while the second section 120 of the first lateral wall 100 has a same length as the second section 220 of the second lateral wall 200. The first section 110 and second section 120 of the first lateral wall 100 are joined together via a first pivot mechanism 131, and the first section 210 and second section 220 of the second lateral wall 200 are joined together via a second pivot mechanism 231. The first pivot mechanism and the second pivot mechanism allow the first section 110 and second section 120 of the first lateral wall 100, and the first section 210 and second section 220 of the second lateral wall 200 to fold together so as to reduce the overall size of the invention. In a preferred embodiment, the second section 120 of the first lateral wall 120 is joined onto the second section 220 of the second lateral wall 200 via a third pivot mechanism 233.

In one embodiment, the end plate 300 is attached to the first end 101 of the first lateral wall 100 via a fourth pivot mechanism 334. The end plate 300 preferably has a shape corresponding to the profile of the V-shaped channel. In one embodiment, the end plate 300 further comprises a latch 310, and the second lateral wall 200 further comprises a catch 260. This latch-and-catch mechanism ensures that the present invention maintains its overall shape when deployed.

In one embodiment, the first lateral wall 100 further comprises a plurality of gusset plates 140. The plurality of gusset plates is configured to laterally abut against the rear end of the semi-trailer's open cargo area, ensuring the present invention remains in the desired working position. In one embodiment, each of the plurality of gusset plates 140 is attached to the first lateral wall via a fifth pivot mechanism 145. It should be noted that the first, second, third, fourth, and/or the fifth pivot mechanism may or may not be the same. Preferably, at least one of the first pivot mechanism 131, the second pivot mechanism 232, the third pivot mechanism 233, the fourth pivot mechanism 334, and the fifth pivot mechanism 145 is hinges. Preferably, the hinges are spring-loaded to facilitate deployment and storage of the present invention.

In one embodiment, the present invention further comprises a bracket 410 having a first end 511 and a second end 412. Each of the first end 411 and the second end 412 of the bracket 410 comprises a claw 414 and a positioning nub 415. In this embodiment, the first lateral wall 100 and the second lateral wall 200 each comprises, adjacent to their respective second end, a positioning hole 151 or 251 to receive the positioning nub 415 and a cutout portion 152 or 252 to receive the claw 414. The bracket 410 connects the second end 102 of the first lateral wall 100 to the second end 202 of the second lateral wall 200, ensuring the structural integrity of the present invention.

The trailer dustpan of the present invention may attach to a rear area of an open semi-trail utilizing any suitable connectors. In one embodiment, the present invention further comprises at least one strap 420, and the second lateral wall 200 further comprises at least one strap hole 260. One end of the at least one strap 420 is attached to the at least one strap hole 260, with another end attached to a rear end of a semi-trailer. In one embodiment, the strap may be a bungee cord equipped with hooks or other connectors to facilitate installation. In a preferred embodiment, the present invention further comprises a plurality of L-shaped mounting arms 430, and the first lateral wall 100 further comprises a plurality of mounting holes 152. The plurality of mounting arms 430 is attached to the first lateral wall 100 via the plurality of mounting holes 152. The plurality of mounting arms 430 is configured to improve the stability of the present invention when deployed. It should be noted that, when deployed, the open end may be positioned lower than the bounded end, creating a slope that channels debris toward the open end.

In an embodiment, the trailer dustpan may be constructed of a lightweight flexible material such as plastics, nylon, plastic coated fabrics, etc. One example of material may be polyethylene terephthalate (PET) which is commonly used in packaging materials, water bottles, and textiles. PET is known for its excellent flexibility and resistance to folding fatigue, making it suitable for repeated bending and folding without significant degradation in performance. Another lightweight and flexible plastic is polypropylene (PP), often utilized in food packaging, medical devices, and automotive components. PP exhibits high flexibility and resilience, allowing it to endure repeated folding cycles while maintaining its structural integrity. Additionally, thermoplastic polyurethane (TPU) is a flexible plastic renowned for its elasticity, abrasion resistance, and tear strength. TPU is commonly found in consumer electronics, sports equipment, and medical devices, offering exceptional flexibility and foldability for applications requiring repeated bending and stretching. These lightweight flexible plastics provide a range of options for manufacturers seeking materials capable of enduring multiple folding cycles while retaining their mechanical properties and performance characteristics.

Although the disclosure has been explained in relation to its preferred embodiment, it is to be understood that many other possible modifications and variations can be made without departing from the spirit and scope of the disclosure.

What is claimed is:

1. A trailer dustpan comprising:
a first lateral wall having a first end and a second end;
a second lateral wall having a first end and a second end;
an end plate;
wherein the first lateral wall and the second lateral wall are joined at an angle to form a V-shaped channel, and the end plate is attached between the first end of the first lateral wall and the first end of the second lateral wall.

2. The trailer dustpan as claimed in claim 1, wherein the first lateral wall and the second lateral wall are joined at a right angle.

3. The trailer dustpan as claimed in claim 1, wherein the first lateral wall comprises a first section and a second section along a length of the first lateral wall, while the second lateral wall comprises a first section and a second section along a length of the second lateral wall.

4. The trailer dustpan as claimed in claim 3, wherein the first section of the first lateral wall has a same length as the first section of the second lateral wall, while the second section of the first lateral wall has a same length as the second section of the second lateral wall.

5. The trailer dustpan as claimed in claim 4, wherein the first section and second section of the first lateral wall are joined together via a first pivot mechanism, and the first section and second section of the second lateral wall are joined together via a second pivot mechanism.

6. The trailer dustpan as claimed in claim 5, wherein the second section of the first lateral wall is joined onto the second section of the second lateral wall via a third pivot mechanism.

7. The trailer dustpan as claimed in claim 6, wherein the end plate is attached to the first end of the first lateral wall via a fourth pivot mechanism.

8. The trailer dustpan as claimed in claim 7, wherein the end plate further comprises a latch, and the second lateral wall further comprises a catch.

9. The trailer dustpan as claimed in claim 7, wherein the first lateral wall further comprises a plurality of gusset plates.

10. The trailer dustpan as claimed in claim 9, wherein each of the plurality of gusset plates is attached to the first lateral wall via a fifth pivot mechanism.

11. The trailer dustpan as claimed in claim 10, wherein at least one of the first pivot mechanism, the second pivot mechanism, the third pivot mechanism, the fourth pivot mechanism, and the fifth pivot mechanism is hinges.

12. The trailer dustpan as claimed in claim 11, wherein the hinges are spring-loaded.

13. The trailer dustpan as claimed in claim 1, further comprising:
a bracket having a first end and a second end;
each of the first end and the second end of the bracket comprising a claw and a positioning nub; and
the first lateral wall and the second lateral wall each comprising, adjacent to their respective second end, a positioning hole to receive the positioning nub and a cutout portion to receive the claw.

14. The trailer dustpan as claimed in claim 13, further comprising:
at least one strap;
the second lateral wall further comprising at least one strap hole;
one end of the at least one strap being attached to the at least one strap hole, with another end attached to a rear end of a semi-trailer.

15. The trailer dustpan as claimed in claim 14, further comprising:
a plurality of L-shaped mounting arms;
the first lateral wall further comprising a plurality of mounting holes;
the plurality of mounting arms being attached to the first lateral wall via the plurality of mounting holes.
